(19) United States
(12) Patent Application Publication
(10) Pub. No.: US 2023/0292752 A1
(43) Pub. Date: Sep. 21, 2023

(54) SYNERGISTIC HERBICIDE COMBINATIONS, COMPOSITIONS AND USE THEREOF

(71) Applicants: UPL Corporation Limited, Port Louis (MU); UPL Europe LTD, Warrington (GB)

(72) Inventors: Alan Pirotte, Houffalize (BE); Géraldine Bailly, Puteaux (FR); Emma Louise Hawkins, Evesham (GB); Christophe Sepulchre de Condé, Pau (FR)

(21) Appl. No.: 18/013,639

(22) PCT Filed: Jun. 30, 2021
(86) PCT No.: PCT/GB2021/051666

§ 371 Date: Dec. 29, 2022

(30) Foreign Application Priority Data
Jul. 1, 2020 (EP) 20305740.1

(51) Int. Cl. A01N 35/10; A01N 43/653; A01N 43/56; A01P 13/00

(52) U.S. Cl. CPC A01N 35/10; A01N 43/653; A01N 43/56; A01P 13/00

(57) ABSTRACT

The present invention relates a synergistic herbicidal combination of cyclohexanediones and at least one other herbicide. The invention also relates to a method of removal or control of weeds and undesirable vegetation using the synergistic herbicidal composition. The invention also relates to a method of removal or control of weeds and undesirable vegetation from non-agricultural land, amenities, forestries, orchards, vines and fruit trees using the synergistic herbicidal composition.

### FIELD OF THE INVENTION

The present invention relates a synergistic herbicidal combination of cyclohexanediones and at least one another herbicide. Particularly, the invention relates to a method of removal or control of weeds and undesirable vegetation using the synergistic herbicidal composition.

### BACKGROUND OF THE INVENTION

Herbicides play an important role in agricultural practices across the world helping in removal of unwanted plants and weeds contaminating the yielding lands. Each herbicide has a spectrum of action and target plants which it can effectively control the growth or aid in complete removal of weeds.

Apart from agriculture, weeds and unwanted plants are a pestering problem in non-crop land which boasts of architectural constructions, amenities such as railways and runways which require utmost precision and no obstructions in its ways. Weeds are also considered a nuisance in places such as golf courses, sports complexes which require large swathes of maintained carpet lawns. In such places, the weeds are a problem, irrespective of its genus or species and target selection is not the focus. These removals require bulk removal and weeding which is cumbersome if done by hand considering the vast expanses. Herbicides can be employed in such cases for the rescue as they can target weeds all at one point in time.

Also, forests and orchards with a clean floor allows better access for harvesting of fruits and valuable material from the forests. Manual weeding in such places can be a challenging and a daunting task and herbicides can be a solution to help with this problem.

It is seen that while herbicides have an effect against a spectrum of weeds, they do not however fight a certain type of other weeds which can hinder complete removal of weeds from the above-mentioned places. Therefore, there is a strong need for mixing two or more herbicides. The combination of herbicides with a favourable profile of action allows the application rate to be reduced in comparison with the individual application of the herbicides to be combined and result into better control of weeds. Mixtures of selected herbicides have several advantages over the use of a single herbicide including (a) an increase in the spectrum of weeds controlled or an extension of weed control over a longer period of time, (b) an improvement in crop safety by using minimum doses of selected herbicides applied in combination rather than a single high dose of one herbicide, and (c) a delay in the appearance of resistant weed species to selected herbicides (Int. J. Agri. Biol, Vol. 6, No. 1, 2004, pages 209-212).

However, the activity and selectivity behaviour of any specific mixture is difficult to predict since the behaviour of each single herbicide in the mixture is often affected by the presence of the other(s) and the activity of the mixture may also vary considerably depending on chemical character, plant species, growth stage, and environmental conditions. Mostly, this practice results in reduced activity of the herbicides in the mixture.

Further, combinations of herbicides are used to control a broader range of weeds. However, the combination of herbicides may not always result in the desired effect. Combination of herbicides may lead to an additive effect or an antagonistic effect. It may also result in phytotoxicity to the crops making it an undesirable combination. Agronomists must therefore, carefully select the herbicides that can be combined to offer a synergistic effect that would control weeds while having no phytotoxic effect on the crop and reduce the chances of development of herbicide resistant weeds.

Clethodim is a selective post-emergence herbicide used to control annual and perennial grasses in a wide variety of broad leaf crops including soybeans, cotton, flax, peanuts, sunflowers, sugarbeets, potatoes, alfalfa, ornamentals and most vegetables. It is able to provide good control of grassy weeds and thus poses a need for combination with other herbicides able to target broad leaf weeds.

US20020004457A1 describes combinations of protoporphyrinogen oxidases inhibitor herbicides with co-herbicides for removal of grassy and broad-leaved weeds. However, it stresses and demonstrates the use of these combinations on weeds of cotton, soy, sunflower, rape and sugarbeet. Thus, it stresses on the agricultural application of the herbicidal combination. It does not provide clarity on use of such a combination for removal of weeds from other crop areas, non-agricultural lands or orchards or forestries.

Thus, there exists a pressing need to address complete removal and control of weeds and undesired vegetation from non-crop lands, orchards and forestries in a time-efficient and cost-efficient way. There exists a need for an effective herbicidal composition which can deliver effective removal of undesired vegetation irrespective of type, physiology and morphology of the vegetation.

The present invention described herein in further specifications addresses this requirement.

### Objectives of the Invention

It is an object of the present invention to address control and complete removal of weeds and undesirable vegetation from crop areas, non-crop lands, orchards and forestries in a time-efficient and cost-efficient way.

It is an object of the present invention to provide for an effective herbicidal combination which can deliver effective removal of undesirable vegetation irrespective of type, physiology and morphology of the vegetation.

Therefore, it is an object of the present invention to provide a synergistic herbicidal combination.

Another object of the present invention is to provide a composition comprising a synergistic herbicidal combination which offers a broader and more complete spectrum of weed control.

Another object of the present invention is to provide a method of controlling weeds at a locus by application of a synergistic herbicidal combinations or compositions.

It is another object of the invention to facilitate removal of undesirable vegetation from non-agricultural land, amenities, forestries and orchards using said composition.

It is an object of this invention to reduce or eradicate nuisance and life hazards caused by growth of undesirable vegetation.

Yet another object of the present invention is to provide a method of increasing yield in a crop by application of a synergistic herbicidal combinations.

Another object of the present invention is to provide a method of improving the plant health by application of a synergistic herbicidal combinations.

### SUMMARY OF THE INVENTION

In accordance with the above objectives, the present invention provides a synergistic combination of cyclohexanedione and at least one other herbicide.

In an aspect, the present invention also provides a synergistic composition comprising a combination of cyclohexanedione and at least one other herbicide for controlling or removal of weeds.

In another aspect, the present invention provides a method of control of weeds comprising applying a synergistic combination of cyclohexanedione and at least one other herbicide at a locus.

Another aspect of the invention provides a method of application at a locus of plant or weed a combination comprising cyclohexanedione and at least one other herbicide.

In yet another aspect, the present invention provides a method for use of said combination or composition comprising applying said combination or composition according to the present invention at the desired location.

In another aspect, the present invention provides a kit comprising said combination or composition according to the present invention.

### DETAILED DESCRIPTION OF THE INVENTION

Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation.

The terms “plants” and “vegetation” include, but are not limited to, germinant seeds, emerging seedlings, plants emerging from vegetative propagules, and established vegetation. The term “weed” refers to and includes any plant which grows where it is not wanted, including pesticide resistant plants.

The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents or adjuvants or excipients not specifically recited therein.

As used herein, the term “control of undesirable vegetation” refers to the interference with the normal growth and development of undesired vegetation. Examples of control activity include, but are not limited to, inhibition of root growth, inhibition of shoot growth, inhibition of shoot emergence, inhibition of seed production, or reduction of weed bio mass. The term “undesirable vegetation” applies to any plant or a part thereof growing in a place which is hindered, disturbed, obstructed by its presence stressing the need for its control or complete removal. Such a plant can be a weedy plant or a crop plant growing in undesirable places. As used herein, the terms “undesirable vegetation”, “undesirable species”, “undesirable plants”, “harmful plants”, “unwanted weeds” or “harmful weeds” are synonymous.

As used herein, the term “effective amount” refers to an amount of the compound that, when ingested, contacted with or sensed, is sufficient to achieve a good level of control.

Apart from agricultural uses, herbicides find their way in many other walks of life and places where unwanted weed growth deters normal functioning or poses a risk to life of human or animal. Beside to weed control in arable crops, it is essential to have suitable solutions to control in railways, amenities and forestry. As an example, weeding of railways is necessary for the safety of passengers and sustainability of infrastructure. It is critical for chemical weeding to be carried out fast and according to regulations that vary alongside the track as vegetation and landscape varies. According to the inventors of the present invention, it was surprisingly found that combinations of cyclohexanedione herbicide with another herbicide was able to tackle the problem in a fast and versatile manner. It also would serve to eliminate the hindrance caused by resistance development in weeds and plants, meanwhile combating a large spectrum of weeds and problematic plants.

Surprisingly, it has been found by the present inventors that the combination of an cyclohexanedione herbicide and a second herbicide results in a synergistic control of undesirable plants at the locus of the desirable crop plants.

According to an aspect, the present invention provides a synergistic combination comprising a cyclohexanedione and at least one other herbicide for control or removal of weeds.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

In an embodiment, the present invention provides preferred combinations, compositions and methods thereof. The methods of the invention include a method of controlling weeds at a locus by applying to the locus the combination or the composition, or a method of increasing yield in a crop by application of the combination or composition, or a method of improving the plant health by application at the locus of the plant the combination or the composition. The embodiments described herein describe the preferred embodiments of all these possible combinations, compositions and methods of the invention.

Thus, an embodiment of the present invention provides a herbicidal combination comprising at least one cyclohexanedione herbicide and at least one another herbicide.

According to an embodiment, the another herbicide is selected from a group comprising of but not limited to acetolactate synthase (ALS) inhibitors or acetohydroxy acid synthase (AHAS), photosystem II inhibitors, acetyl CoA carboxylase (ACCase) inhibitors, synthetic auxins, auxin transport inhibitors, photosystem I inhibitors, 5-enolpyruvylshikimate-3-phosphate (EPSP) synthase inhibitors, microtubule assembly inhibitors, fatty acid and lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, or organoarsenicals.

An embodiment of the present invention may be a herbicidal combination comprising at least one cyclohexanedione herbicide and at least one another herbicide selected from the group of PPO inhibitors, Acetyl CoA Carboxylase inhibitors (ACCase inhibitors), ALS inhibitors or auxin-regulated pathway disruptors or combinations thereof.

In an embodiment, cyclohexanedione herbicide is first herbicide preferably clethodim.

In an embodiment, PPO inhibitor is selected from group of diphenylether, N-phenylphthalimide, Phenylpyrazole Oxadiazole, Thiadiazole, triazolinone, Oxazolidinedione, pyrimidinedione or combinations thereof.

In an embodiment, PPO inhibitor is diphenylether.

In an embodiment, PPO inhibitor is N-phenylphthalimide.

In an embodiment, PPO inhibitor is aryl triazolinone.

In an embodiment, PPO inhibitor is pyrimidinedione

In an embodiment, PPO inhibitor is selected from acifluorfen, fomesafen, lactofen, flumiclorac, flumioxazin, sulfentrazone, carfentrazone, fluthiacet-ethyl and saflufenacil, azafenidin, benzfendizone, bifenox, butafenacil, carfentrazone, carfentrazone-ethyl, chlomethoxyfen, cinidon-ethyl, fluazolate, flufenpyr-ethyl, flumiclorac-pentyl, fluoroglycofen-ethyl, fluthiacet-methyl, fomesafen, halosafen, lactofen, oxadiargyl, oxadiazon, oxyfluorfen, pentoxazone, profluazol, pyraclonil, pyraflufen-ethyl, saflufenacil, thidiazimin, trifludimoxazin and tiafenacil.

In preferred embodiment the PPO inhibitor is selected from acifluorfen, acifluorfen salts, fomesafen, lactofen, oxyfluorfen, fumiclorac, flumioxazin, oxadiazon, saflufenacil, fluthiacet-methyl, carfentrazone, carfentrazone-ethyl, sulfentrazone, pyraflufen and pyraflufen-ethyl.

In preferred embodiment, the PPO inhibitor is carfentrazone or carfentrazone-ethyl.

In yet another specific embodiment, the PPO inhibitor is pyraflufen or pyraflufen-ethyl.

In an embodiment the Acetyl CoA Carboxylase (ACCase) Inhibitors is selected from Aryloxyphenoxypropionates (FOPs), Cyclohexanediones (DIMs) and Phenylpyrazoline.

In an embodiment the ACCase Inhibitors is selected from the group consisting of clodinafop-propargyl, fenoxaprop, haloxyfop, metamifop, cyhalofop-butyl, diclofop-methyl, fenoxaprop-P-ethyl, fluazifop-P-butyl, haloxyfop-etotyl, haloxyfop-methyl, haloxyfop-P-methyl, quizalofop-P-ethyl, propaquizafop, metamifop, quizalofop-P-tefuryl, fluazifop-butyl, alloxydim, butroxydim, clethodim, cycloxydim, profoxydim, sethoxydim, tepraloxydim, tralkoxydim, pinoxaden and/or combinations thereof.

In an embodiment, the ALS inhibitor is selected from the group consisting of:
(i) an imidazolinone herbicide;
(ii) a sulfonyl amino-carbonyltriazolinone herbicide;
(iii) a sulfonylurea herbicide;
(iv) a pyrazole herbicide;
(v) a triazolpyramidine herbicide; and
(vi) a triazolone herbicide;

In an embodiment, the ALS inhibitor herbicide is an imidazolinone herbicide.

In an embodiment, the imidazolinone herbicide is selected from the group consisting of imazamethabenz, imazamox, imazapic, imazapyr, imazaquin, and imazethapyr.

In an embodiment, the ALS inhibitor is a triazolone herbicide.

In an embodiment, the triazolone herbicide is selected from the group consisting of amicarbazone, bencarbazone, carfentrazone, flucarbazone, ipfencarbazone, propoxycarbazone, sulfentrazone, and thiencarbazone.

In an embodiment, the triazolone herbicide is carfentrazone or carfentrazone-ethyl.

In an embodiment, the ALS inhibitor herbicide is a sulfonylamino-carbonyltriazolinone herbicide.

In an embodiment, the sulfonylamino-carbonyltriazolinone herbicide is flucarbazone or flucarbazone-sodium.

In an embodiment, the ALS inhibitor herbicide is a sulfonylurea herbicide.

In an embodiment, the sulfonylurea herbicide is selected from the group consisting of amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, trflusulfuron, and tritosulfuron.

In an embodiment, the ALS inhibitor herbicide is a pyrazole herbicide.

In an embodiment, the pyrazole herbicide is selected from the group consisting of azimsulfuron, cyclopyranil, difenzoquat, halosulfuron, flazasulfuron, metazachlor, metazosulfuron, pyrazosulfuron, pyraclonil, pyroxasulfone, benzofenap, pyrasulfotole, pyrazolynate, pyrazoxyfen, tolpyralate, topramezone, fluazolate, nipyraclofen, pinoxaden, and pyraflufen.

In an embodiment, the ALS inhibitor herbicide is a triazolopyrimidine herbicide.

In an embodiment, the triazolopyrimidine herbicide is selected from the group consisting of chloransulam, diclosulam, florasulam, flumetsulam, metosulam, penoxsulam, and pyroxsulam.

In one preferred embodiment, the ALS inhibitor herbicide is selected from the group consisting of imazamox, imazapic, imazapyr, imazethapyr, carfentrazone, flucarbazone, sulfentrazone, flucarbazone, amicarbazone, flucarbazone-sodium, bensulfuron, halosulfuron, pyrazosulfuron, flazasulfuron, sulfosulfuron, trifloxysulfuron, metsulfuron, metazachlor, pinoxaden, pyraflufen, diclosulam, and penoxsulam.

In an embodiment the auxin-regulated pathway disruptor is selected from 2,4-D, 2,4-DB, MCPA, MCPB, Mecoprop, Dicamba, Clopyralid, Fluroxypyr, Picloram, Triclopyr, Aminopyralid, Aminocyclopyrachlor, Quinclorac, Diflufenzopyr and/or combinations thereof.

The second herbicide may be selected from the herbicides listed above in any of the embodiments although first and second herbicides may not be the same.

According to another aspect the present invention provides a composition comprising at least one cyclohexanedione herbicide and at least one other herbicide selected from the group of PPO inhibitors, an Acetyl CoA Carboxylase (ACCase inhibitor), an ALS inhibitor or an auxin-regulated pathway disruptor or combinations thereof.

According to another aspect the present invention provides a composition comprising at least one cyclohexanedione herbicide and at least one other herbicide selected from the group of PPO inhibitors, an Acetyl CoA Carboxylase (ACCase inhibitor), an ALS inhibitor or an auxin-regulated pathway disruptor or combinations thereof and at least one agrochemically acceptable carriers.

The acceptable carrier may be any one or a combination of adjuvants.

Accordingly, the present invention provides a herbicide composition comprising:
a) a combination of cyclohexanedione herbicide and another herbicide selected from the group of PPO inhibitors, an Acetyl CoA Carboxylase (ACCase inhibitor), an ALS inhibitor or an auxin-regulated pathway disruptor or combinations thereof and
b) an adjuvant.

In an embodiment the herbicide composition comprising:
a) a combination of clethodim and another herbicide selected from the group of PPO inhibitors, an Acetyl CoA Carboxylase (ACCase inhibitor), an ALS inhibitor or an auxin-regulated pathway disruptor or combinations thereof and
b) an adjuvant.

In another embodiment of the present invention, the compositions may comprise from about from about 0.1% to about 99% by weight of the herbicide.

In an embodiment the composition may contain from about 0.1% to about 15% by weight of the adjuvant.

In another embodiment, the present invention provides a composition comprising a synergistic combination of clethodim and at least one another herbicide for control or removal of weeds and undesirable vegetation, wherein another herbicide is selected from the group of a PPO inhibitor, an ACCase inhibitor, an ALS inhibitor or an auxin-regulated pathway disruptor.

In another embodiment, the present invention provides a formulation comprising a synergistic combination of clethodim and at least one another herbicide for control or removal of weeds and undesirable vegetation, wherein another herbicide is selected from the group of a PPO inhibitor, an ACCase inhibitor, an ALS inhibitor or an auxin-regulated pathway disruptor, together with an acceptable carrier.

The acceptable carrier may be any one or a combination of adjuvants, co-solvents, surfactants, colorants, emulsifiers, thickeners, antifreeze agents, biocides, antifoam agents, stabilizers, wetting agents or a mixture thereof which may be optionally added to the compositions of the present invention.

The surfactants may be selected from non-ionic, anionic or cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether. Some non-limiting examples of emulsifiers used in the compositions of the present invention may be polyoxyethylene (20) sorbitan monooleate and variants, polyoxyethylene (40) sorbitol hexaoleate and variants, sodium dioctyl sulfosuccinate, calcium dodecylbenzene sulphonate, alkoxylates, etc.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethyl celluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinyl acrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutyl ether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable & Animal Fats, Vegetable & Animal Fats Sulfate, Vegetable & Animal Oil, Vegetable & Animal Oil Sulfate, Vegetable & Animal Wax, Vegetable & Animal Wax Sulfate.

Representative organic liquids which can be employed in preparing the emulsifiable concentrates of the present invention are the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of the emulsifiable concentrate. The formulations can also contain other compatible additives, for example, plant growth regulators and other biologically active compounds used in agriculture.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethyl sulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

Additionally, the compositions of the present invention may also comprise adjuvants. Preferred adjuvants for the composition may include fatty acid esters, unsaturated fatty acid esters, methylated esters of fatty acids, methylated esters of unsaturated fatty acids, methyl soyate and so forth.

The compositions of the present invention may also comprise solvents such as alcohols (methanol, ethanol, propanol, etc.), dimethyl adipate, dimethyl glutarate, dimethyl succinate, or combinations thereof.

The compositions of the present invention may further comprise an additional pesticide or active ingredient which may be selected from but not limited to herbicides, insecticides, fungicides, acaricides, nematicides, weedicides, biopesticides, fertilizers, safeners, synergists, mycorrhiza, micronutrients, algicides, antifeedants, avicides, bactericides, bird repellents, chemosterilants, insect attractants, insect repellents, mammal repellents, mating disruptors, molluscicides, plant activators, plant-growth regulators, rodenticides, virucides, derivatives thereof and biological control agents.

In an embodiment the safener can be selected from the group comprising isoxadifen-ethyl, cloquintocet-mexyl, mefenpyr-diethyl, naphthalic anhydride, oxabetrinil, benzenesulfonamide, N-(aminocarbonyl)-2-chlorobenzenesulfonamide (2-CB SU), daimuron, dichloroacetamide, dicyclonon, fenchlorazole-ethyl, fenclorim, fluxofenim, Dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl (CGA-185072), 1-dichloroacetylhexahydro-3,3,8a-trimethylpyrrolo[1,2-α]pyrimidin-6-(2H-one) (BAS-145138), dichloromethyl-1,3-di oxolane (MG-191), quinolinyloxyacetate compounds, or agriculturally acceptable salts, esters, or mixtures thereof.

Without departing from the scope of the subject matter, the mixture and formulations of the present subject matter may be applied in conjunction with one or more co-herbicides to control a wider variety of undesirable vegetation. When used in conjunction with co-herbicides, the composition can be formulated with the co-herbicide or co-herbicides, tank mixed with the co-herbicide or co-herbicides or applied sequentially with the co-herbicide or co-herbicides. Some of the co-herbicides that can be employed in conjunction with the mixture of the present subject matter include but are not limited to 2,4-D, 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isoctyl, 2,4-D-isopropyl, 2,4-D-isopropylammonium, 2,4-D-sodium, 2,4-D-isopropanolammonium, 2,4-D-trolamine, 2,4-DB, 2,4-DB-butyl, 2,4-DB-dimethylammonium, 2,4-DB-isoctyl, 2,4-DB-potassium, 2,4-DB-sodium, dichlorprop, dichlorprop-butotyl, dichlorprop-dimethylammonium, dichlorprop-isoctyl, dichlorprop-potassium, dichlorprop-P, dichlorprop-P-dimethyl ammonium, dichlorprop-P-potassium, dichlorprop-P-sodium, MCPA, MCPA-butotyl, MCPA-dimethylammonium, MCPA-2-ethylhexyl, MCPA-potassium, MCPA-sodium, MCPA-thioethyl, MCPB, MCPB-ethyl, MCPB-sodium, mecoprop, mecoprop-butotyl, mecoprop-sodium, mecoprop-P, mecoprop-P-butotyl, mecoprop-P-dimethylammonium, mecoprop-P-2-ethylhexyl, mecoprop-P-potassium, naproanilide, clomeprop, 2,3,6-TBA, dicamba, dicamba-butotyl, dicamba-diglycolamine, dicamba-dimethylammonium, dicamba-diolamine, dicamba-isopropylammonium, dicamba-potassium, dicamba-sodium, dichlobenil, picloram, picloram-dimethyl ammonium, picloram-isoctyl, picloram-potassium, picloram-triisopropanolammonium, picloram-triisopropylammonium, picloram-trolamine, triclopyr, triclopyr-butotyl, triclopyr-triethylammonium, clopyralid, clopyralidolamine, clopyralid-potassium, clopyralid-triisopropanolammonium, aminopyralid, naptalam, naptalam-sodium, benazolin, benazolin-ethyl, quinclorac, quinmerac, diflufenzopyr, diflufenzopyr-sodium, fluroxypyr, fluroxypyr-2-butoxy-1-methylethyl, fluroxypyr-meptyl, chlorflurenol, chlorflurenol-methyl, aminocyclopyrachlor, aminocyclopyrachlor-methyl, aminocyclopyrachlor-potassium, chlorotoluron, diuron, fluometuron, linuron, isoproturon, metobenzuron, tebuthiuron, dimefuron, isouron, karbutilate, methabenzthiazuron, metoxuron, monolinuron, neburon, siduron, terbumeton, trietazine, metobromuron, simazine, atrazine, atratone, simetryn, prometryn, dimethametryn, hexazinone, metribuzin, teroutnyiazine, cyanazine, ametryn, cybutryne, triaziflam, indaziflam, terbutryn, propazine, metamitron, prometon, bromacil, bromacyl-lithium, lenacil, terbacil, propanil, cypromid, swep, desmedipham, phenmedipham, bromoxynil, bromoxynil-octanoate, bromoxynil-heptanoate, ioxynil, ioxynil-octanoate, ioxynil-potassium, ioxynil-sodium, pyridate, bentazone, bentazone-sodium, amicarbazone, methazole, pentanochlor, paraquat, diquat, nitrofen, chlomethoxyfen, bifenox, acifluorfen, acifluorf en-sodium, fomesafen, fomesafen-sodium, oxyfluorfen, lactofen, aclonifen, ethoxyfen-ethyl (HC-252), fluoroglycofen-ethyl, fluoroglycofen, chlorphthalim, flumioxazin, flumiclorac, flumiclorac-pentyl, cinidon-ethyl, fluthiacet, fluthiacet-methyl, oxadiargyl, oxadiazon, sulfentrazone, carfentrazone-ethyl, thidiazimin, pentoxazone, azafenidin, isopropazole, pyraflufen-ethyl, benzfendizone, butafenacil, saflufenacil, flupoxam, fluazolate, profluazol, pyraclonil, flufenpyr-ethyl, bencarbazone, ethyl[3-(2-chloro-4-fluoro-5-(3-methyl-2,6-dioxo-4-trifluoromethyl-3,6-dihydro-2H-pyrimidin-1-yl)phenoxy)pyridin-2-yloxy]acetate (SYN-523), norflurazon, chloridazon, metflurazon, pyrazolynate, pyrazoxyfen, benzofenap, topramezone, pyrasulfotole, amitrole, fluridone, flurtamone, diflufenican, methoxyphenone, clomazone, sulcotrione, mesotrione, tembotrione, tefuryltrione, bicyclopyrone, isoxaflutole, difenzoquat, difenzoquat-metilsulfate, isoxachlortole, benzobicyclon, picolinafen, beflubutamid, diclotop-methyl, diclotop, pyriphenop-sodium, fluazifop-butyl, fluazifop, fluazifop-P, fluazifop-P-butyl, haloxyfop-methyl, haloxyfop, haloxyfop-etotyl, haloxyfop-P, haloxyfop-P-methyl, quizalofop-ethyl, quizalofop-P, quizalofop-P-ethyl, quizalofop-P-tefuryl, cyhalofop-butyl, fenoxaprop-ethyl, fenoxaprop-P, fenoxaprop-P-ethyl, metamifop-propyl, metamifop, clodinafop-propargyl, clodinafop, propaquizafop, alloxydim-sodium, alloxydim, clethodim, sethoxydim, tralkoxydim, butroxydim, tepraloxydim, profoxydim, cycloxydim, flamprop-M-methyl, flamprop-M, flamprop-M-isopropyl, chlorimuron-ethyl, chlorimuron, sulfometuron-methyl, sulfometuron, primisulfuron-methyl, primisulfuron, bensulfuron-methyl, bensulfuron, chlorsulfuron, metsulfuron-methyl, metsulfuron, cinosulfuron, pyrazosulfuron-ethyl, pyrazosulfuron, azimsulfuron, rimsulfuron, imazosulfuron, cyclosulfamuron, prosulfuron, flupyrsulfuron-methyl-sodium, flupyrsulfuron, triflusulfuron-methyl, triflusulfuron, halosulfuron-methyl, halosulfuron, thifensulfuron-methyl, thifensulfuron, ethoxysulfuron, oxasulfuron, ethametsulfuron, ethametsulfuron-methyl, iodosulfuron, iodosulfuron-methyl-sodium, sulfosulfuron, triasulfuron, tribenuron-methyl, tribenuron, tritosulfuron, foramsulfuron, trifloxysulfuron, trifloxysulfuron-sodium, mesosulfuron, mesosulfuron-methyl, orthosulfamuron, flucetosulfuron, amidosulfuron, propyrisulfuron, metazosulfuron, iofensulfuron, flumetsulam, metosulam, diclosulam, cloransulam-methyl, florasulam, penoxsulam, pyroxsulam, imazapyr, imazapyr-isopropylammonium, imazethapyr, imazethapyr-ammonium, imazaquin, imazaquin-ammonium, imazamox, imazamox-ammonium, imazamethabenz, imazamethabenz-methyl, imazapic, pyrithiobac-sodium, bispyribac-sodium, pyriminobac-methyl, pyribenzoxim, pyriftalid, pyrimisulfan, triafamone, flucarbazone, ilucarbazone-sodium, propoxycarbazone-sodium, propoxycarbazone or thiencarbazone, glyphosate, glyphosate-sodium, glyphosate-potassium, glyphosate-ammonium, glyphosate-di ammonium, glyphosate-isopropylammonium, glyphosate-trimesium, glyphosate-sesquisodium, glufosinate, glufosinate-ammonium, glufosinate-P, glufosinate-P-ammonium, glufosinate-P-sodium, bilanafos, bilanafos-sodium, cinmethylin, trifluralin, oryzalin, nitralin, pendimethalin, ethalfluralin, benfluralin, prodiamine, butralin, dinitramine, bensulide, napropamide, propyzamide, pronamide, amiprofos-methyl, butamifos, anilofos, piperophos, propham, chlorpropham, barban, carbetamide, daimuron, cumyluron, bromobutide, methyldymron, asulam, asulam-sodium, dithiopyr, thiazopyr, chlorthal-dimethyl, chlorthal, diphenamid, alachlor, metazachlor, butachlor, pretilachlor, metolachlor, thenylchlor, pethoxamid, acetochlor, propachlor, dimethenamid, dimethenamid-P, propisochlor, dimethachlor, molinate, dimepiperate, pyributicarb, EPTC, butylate, vernolate, pebulate, cycloate, prosulfocarb, esprocarb, thiobencarb, triallate, diallate, orbencarb, etobenzanid, flufenacet, mefenacet, tridiphane, cafenstrole, fentrazamide, oxaziclomefone, indanofan, benfuresate, pyroxasulfone, fenoxasulfone, dalapon, dalapon-sodium, TCA-sodium, trichloroacetic acid, MSMA, DSMA, CMA, endothall, endothall-dipotassium, endothall-sodium, endothall-mono(N,N-dimethylalkylammonium), ethofumesate, sodium chlorate, pelargonic acid (nonanoic acid), fosamine, fosamine-ammonium, pinoxaden, ipfencarbazone, aclolein, ammonium sulfamate, borax, chloroacetic acid, sodium chloroacete, cyanamide, methylarsonic acid, dimethylarsinic acid, sodium dimethylarsinate, dinoterb, dinoterb-ammonium, dinoterb-diolamine, dinoterb-acetate, DNOC, ferrous sulfate, flupropanate, flupropanate-sodium, isoxaben, mefluidide, mefluidide-diolamine, metam, metam-ammonium, metam-potassium, metam-sodium, methyl isothiocyanate, pentachlorophenol and sodium pentachlorophenoxide.

According to an embodiment, concentrated formulations can be dispersed in water, or another liquid, for application, or formulations can be dust-like or granular. The formulations are prepared according to procedures which are conventional in the agricultural chemical art, but which are novel and important because of the presence therein of a composition. The formulations that are applied most often are aqueous suspensions or emulsions. Either such water-soluble, water-suspendable, or emulsifiable formulations are solids, usually known as wettable powders, or liquids, usually known as emulsifiable concentrates, aqueous suspensions, or suspension concentrates. The present disclosure contemplates all vehicles by which the compositions can be formulated for delivery and use as an herbicide.

The compositions of the present invention may also be formulated as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ULV) liquid, ultra low volume (ULV) suspension, water dispersible granules or tablets, water dispersible powder for slurry treatment, water soluble granules or tablets, water soluble powder for seed treatment and wettable powder. More specifically, the compositions are formulated as solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF).

In an embodiment, the formulations may contain agriculturally acceptable adjuvant surfactants to enhance deposition, wetting and penetration of the composition onto the target weed. These adjuvant surfactants may optionally be employed as a component of the formulation.

According to another embodiment, the present invention provides a method of making a synergistic composition for control or removal of weeds and undesirable vegetation, wherein the method comprises mixing clethodim and at least one another herbicide.

According to another embodiment, the present invention provides a method of making a synergistic composition for control or removal of weeds, wherein the method comprises mixing clethodim and an additional herbicide selected from a PPO inhibitor, an ACCase inhibitor, an ALS inhibitor or an auxin-regulated pathway disruptor.

According to an embodiment, clethodim and the additional herbicide may be mixed at the time of application or on the point of application. The point of application refers to the locus of application of the said herbicides. The said locus could be a weed, an area adjacent to the weed, soil adapted to support growth of the weed, a root of the weed and/or foliage of the weed.

In another aspect, the present invention may provide a method of controlling weeds and undesirable vegetation at a locus, said method comprising applying to the locus a herbicidal combination comprising:
at least one cyclohexanedione herbicide and
at least one other herbicide selected from the group of Protoporphyrinogen Oxidase (PPO) Inhibitors, an Acetyl CoA Carboxylase (ACCase inhibitor), an ALS inhibitor or an auxin-regulated pathway disruptor or combinations thereof.

Yet, another aspect of the present invention may provide a method of increasing yield in a crop by application of a combination comprising:
at least one cyclohexanedione herbicide and
at least one other herbicide selected from the group of Protoporphyrinogen Oxidase (PPO) Inhibitors, an Acetyl CoA Carboxylase (ACCase inhibitor), an ALS inhibitor or an auxin-regulated pathway disruptor or combinations thereof.

Another aspect of the present invention may provide a method of improving the plant health, said method comprising application at the locus of the plant a combination comprising:
at least one cyclohexanedione herbicide and
at least one another herbicide selected from the group of Protoporphyrinogen Oxidase (PPO) Inhibitors, an Acetyl CoA Carboxylase (ACCase inhibitor), an ALS inhibitor or an auxin-regulated pathway disruptor or combinations thereof.

The invention also provides methods for selective control of weeds. In one embodiment, a method includes contacting a composition of the invention onto a crop plant in need of weed control or at risk of undesirable vegetation, in an amount effective to provide weed control in the crop.

In a specific embodiment, the target application for present composition is non-agricultural land, amenities, forestries, orchards, vines and fruit trees.

In an embodiment, the weed removal is not restricted to crop land or agricultural land only. The weeds are targeted in non-agricultural areas such as, but not limited to, forestries, railways, infrastructure, amenities, companies, factories, roads and runways, sidewalks, highways, dividers, medians, pipelines, public utility lines, pumping stations, transformer stations, substations, around airports, electric utilities, commercial buildings, manufacturing plants, storage yards, rail yards, hangars, fence lines, parking lots, parkways, sedges, post-harvest crop lands, beneath greenhouse benches and around golf courses.

According to another embodiment, the composition is suitable for control or removal of undesirable vegetation and weeds in orchards, vines and fruit trees. The fruit trees may refer, but is not limited by the examples, to grapes, pomes, apples, stone fruits, olives, citrus, etc.

The herbicidal composition of the present invention may be applied to undesirable vegetation or may be applied to a place where they grow. Further, it may be applied at any time either before or after the emergence of the undesired plants. Further, the herbicidal composition of the present invention may take various application forms such as soil application, foliar application, irrigation application, and submerged application, and it can be applied to agricultural fields such as upland fields, orchards and paddy fields, and non-cropland such as ridges of fields, fallow fields, play grounds, golf courses, vacant lands, forests, factory sites, railway sides and roadsides. Further the application may happen on locus of plant such as leaves, stems, patterns, flowers, buds, fruits, seeds, sprout, roots, tubers, tuberous roots, shoots, cuttings, generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

The herbicidal combination of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, sugarcane etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

According to an embodiment, the weeds targeted are grassy weeds and broad-leaved weeds.

As per an embodiment, the weeds may be crop plants growing in unwanted and non-agricultural areas, spaces and amenities as described in previous embodiments.

The herbicidal composition of the present invention can control a wide range of undesired plants such as annual weeds and perennial weeds. The undesired plants to be controlled by the herbicidal composition of the present invention may, for example, be specifically cyperaceae such as green kyllinga (Kyllinga brevifolia Rottb. var. leiolepis), sedge (Cyperus spp.) (such as purple nutsedge (Cyperus rotundus L.), smallflower umbrella sedge (Cyperus difformis L.), yellow nutsedge (Cyperus esculentus L.) or amur cyperus (Cyperus microiria Steud.)); gramineae such as barnyardgrass (Echinochloa crus-galli L., Echinochloa oryzicola vasing.), crabgrass (Digitaria spp.) (such as summergrass (Digitaria ciliaris (Retz.) Koel), large crabgrass (Digitaria sanguinalis L.), violet crabgrass (Digitaria violascens Link) or Digitaria horizontalis Willd.), green foxtail (Setaria viridis (L.)), giant foxtail (Setaria faberi Herrm.), goosegrass (Eleusine indica L.), sorghum (Sorghum spp.) (such as johnsongrass (Sorghum halepense (L.) Pers.) or shattercane (Sorghum bicolor (L.) Moench.)), oat (Avena spp.) (such as wild oat (Avena fatua L.)), annual bluegrass (Poa annua L.), panic grass (Panicum spp.) (such as guinea grass (Panicum maximum Jacq.) or fall panicum (Panicum dichotomiflorum (L.) Michx.)), signal grass (Brachiaria spp.) (such as plantain signal grass (Brachiaria plantaginea (LINK) Hitchc.), palisade signal grass (Brachiaria decumbens Stapf) or mauritius signal grass (Brachiaria mutica (Forssk.) Stapf)), paspalum (Paspalum spp.), itchgrass (Rottboellia cochinchinensis (LOUR.) W.D.CLAYTON) or bermudagrass (Cynodon dactylon Pers.); scrophulariaceae such as persian speedwell (Veronica persica Poir.) or corn speedwell (Veronica arvensis L.); compositae such as beggar ticks (Bidens spp.) (such as hairy beggarticks (Bidens pilosa L.), devils berggarticks (Bidens frondosa L.), Bidens biternata (Lour.) Merr. et Sherff or beggarticks (Bidens subalternans DC.)), hairy fleabane (Conyza bonariensis (L.) Cronq.), horseweed (Erigeron canadensis L.), dandelion (Taraxacum officinale Weber), common cocklebur (Xanthium strumarium L.) or common ragweed (Ambrosia artemisiifolia L.); leguminosae such as rattlepod or rattlebox (Crotalaria spp.) (such as sunn-hemp (Crotalaria juncea L.)), poison bean (Sesbania spp.) (such as rostrate sesbania (Sesbania rostrata Bremek. & Oberm.) or sesbania pea (Sesbania cannabina (Retz.) Pers.)), white clover (Trifolium repens L.) or common lespedeza (Lespedeza striata (Thunb.) Hook. et. Arn.); caryophyllaceae such as sticky chickweed (Cerastium glomeratum Thuill.) or common chickweed (Stellaria media L.); euphorbiaceae such as garden spurge (Euphorbia hirta L.), threeseeded copperleaf (Acalypha australis L.) or fireplant (Euphorbia heterophylla L.); plantaginaceae such as asiatic plantain (Plantago asiatica L.); oxalidaceae such as creeping woodsorrel (Oxalis corniculata L.); apiaceae such as lawn pennywort (Hydrocotyle sibthorpioides Lam.); violaceae such as violet (Viola mandshurica W. Becker); iridaceae such as blue-eyedgrass (Sisyrinchium rosulatum Bicknell); geraniaceae such as carolina geranium (Geranium carolinianum L.); labiatae such as purple deadnettle (Lamium purpureum L.) or henbit (Lamium amplexicaule L.); malvaceae such as velvetleaf (Abutilon theophrasti MEDIC.) or prickly sida (Sida spinosa L.); convolvulaceae such as ivy-leaved morningglory (Ipomoea hederacea (L.) Jacq.), common morningglory (Ipomoea purpurea ROTH), cypressvine morningglory (Ipomoea guamoclit L.), (Ipomoea grandifolia (DAMMERMANN) O'DONNELL, hairy merremia (Merremia aegyptia (L.) URBAN) or field bindweed (Convolvulus arvensis L.); chenopodiaceae such as common lambsquarters (Chenopodium album L.); portulacaceae such as common purslane (Portulaca oleracea L.); amaranthaceae such as pigweed (Amaranthus spp.) (such as prostrate pigweed (Amaranthus blitoides S. Wats.), livid amaranth (Amaranthus lividus L.), purple amaranth (Amaranthus blitum L.), smooth pigweed (Amaranthus hybridus L., Amaranthus patulus Bertol.), powell amaranth (Amaranthus powellii S. Wats.), slender amaranth (Amaranthus viridis L.), palmer amaranth (Amaranthus palmeri S. Wats.), redroot pigweed (Amaranthus retroflexus L.), tall waterhemp (Amaranthus tuberculatus (Moq.) Sauer.), common waterhemp (Amaranthus tamariscinus Nutt.), thorny amaranth (Amaranthus spinosus L.), ataco (Amaranthus quitensis Kunth.) or Amaranthus rudis Sauer.); solanaceae such as black nightshade (Solanum nigrum L.); polygonaceae such as spotted knotweed (Polygonum lapathifolium L.) or green smartweed (Polygonum scabrum MOENCH); cruciferae such as flexuous bittercress (Cardamine flexuosa WITH.); cucuribitaceae such as burcucumber (Sicyos angulatus L.); or commelinaceae such as common dayflower (Commelina communis L.).

Further, the herbicidal composition of the present invention is capable of controlling cyperaceae such as purple nutsedge (Cyperus rotundus L.) or yellow nutsedge (Cyperus esculentus L.); gramineae such as barnyardgrass (Echinochloa crus-galli L., Echinochloa oryzicola vasing.), summergrass (Digitaria ciliaris (Retz.) Koel), large crabgrass (Digitaria sanguinalis L.), shattercane (Sorghum bicolor (L.) Moench.), wild oat (Avena fatua L.), guinea grass (Panicum maximum Jacq.), signal grass (Brachiaria spp.) or bermudagrass (Cynodon dactylon Pers.); scrophulariaceae such as persian speedwell (Veronica persica Poir.); compositae such as hairy beggarticks (Bidens pilosa L.) or common ragweed (Ambrosia artemisiifolia L.); leguminosae such as sunn-hemp (Crotalaria juncea L.), rostrate sesbania (Sesbania rostrata Bremek. & Oberm.) or common lespedeza (Lespedeza striata (Thunb.) Hook. et Arn.); euphorbiaceae such as fireplant (Euphorbia heterophylla L.); malvaceae such as velvetleaf (Abutilon theophrasti MEDIC.); convolvulaceae such as ivy-leaved morningglory (Ipomoea hederacea (L.) Jacq.) or field bindweed (Convolvulus arvensis L.); or amaranthaceae such as redroot pigweed (Amaranthus retroflexus L.), which are problematic as noxious weeds in agricultural fields such as upland fields and orchards, and non-cropland such as golf courses, railway sides and roadsides, in a wide application timing including before and after the emergence.

The target weeds may be selected from Taraxacum officinale Weber (dandelion, TAROF), Galium aparine (cleavers, GALAP), Stellaria media (chickweed, STEME), Senecio sp. (groundsel, SENSS), Veronica sp. (speedwells, VERSS), Phalaris sp. (Canary grasses, PHASS), Alopecurus myosuroides Huds. (blackgrass, ALOMY), Amaranthus palmeri (Palmer amaranth, AMAPA), Amaranthus retroflexus (common amaranth, AMARE) Amaranthus viridis (slender amaranth, AMAVI), Avena fatua (wild oat, AVEFA), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Bromus sp. or Anisantha sp (bromes, BROSS), Convolvulus arvensis (field bindweed, CONAR), Cenchrus echinatus (southern sandbur, CENEC), Digitaria sp. (crabgrasses, DIGSS) Echinochloa crus-galli (barnyardgrass, ECHCG), Echinochloa colonum (junglerice, ECHCO), Eleusine indica Gaertn. (goosegrass, ELEIN), Elymus repens (quackgrass, AGRRE), Geranium sp (cranesbills, GERSS), Lolium multiflorum Lam. (Italian ryegrass, LOLMU), Panicum dichotomiflorum Michx. (fall panicum, PANDI), Panicum miliaceum L. (wild-proso millet, PANMI), Poa sp. (meadow grasses, POASS), Sesbania exaltata (hemp sesbania, SEBEX), Setaria faberi Herrm. (giant foxtail, SETFA), Setaria sp. (foxtails, SETSS), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Malva species (mallow, MALSS), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Sonchus sp. (sow-thistles, SONS S), Solanum ptychanthum (eastern black nightshade, SOLPT), Tridax procumbens (coat buttons, TRQPR), Rumex dentatus (RUMDE) or Xanthium strumarium (common cocklebur, XANST).

In an embodiment the target grass weeds are selected from LOLSS, BROSS, ECHSS, DIGSS and SETSS.

In an embodiment the dicot weeds targeted are selected from ERISS, GERSS, Sonchus sp., CONAR and Malva sp.

In particular embodiments, a synergistic effect of the compound combinations or compositions according to the invention is present when applied individually on a given weed, either pre- or post-emergent.

These combinations or compositions as described above may be applied to the locus of the weeds, in an herbicidally effective amount.

In an embodiment, the total amount of the cyclohexanedione herbicide in the composition may be in the range of 0.1 to 99% by weight, preferably 0.5 to 80% by weight.

In an embodiment the effective amount of active ingredient, preferably clethodim is in the range of about from 5% to 50% by weight, in particular in the range of about from 5% to 35% by weight of the total weight of the composition.

In an embodiment the compositions of the present invention comprising clethodim in an amount in the range of 50 g/L to 500 g/L.

In an embodiment the compositions of the present invention comprising clethodim in an amount in the range of 50 g/L to 400 g/L.

In an embodiment the compositions of the present invention comprising clethodim in an amount in the range of 50 g/L to 300 g/L.

In an embodiment the compositions of the present invention comprising clethodim in an amount in the range of 80 g/L to 300 g/L.

In an embodiment, the total amount of the second active in the composition may be in the range of 0.1 to 99% by weight.

In an embodiment, the effective amount of active compounds used in the composition may be varied based on the type of formulation.

As per an embodiment, the components of the composition of the present disclosure can be applied either separately or as part of a multipart herbicidal system. The components may be applied as ready mix or a tank-mix. The components may be applied sequentially in any order or together as a premix or a tank mix. The components demonstrate synergy when applied in any method.

In one embodiment the compositions of present invention comprising clethodim and at least one herbicide selected from carfentrazone or carfentrazone-ethyl or pyraflufen or pyraflufen-ethyl.

In an embodiment, clethodim may be used for control of weeds at a dose of 10 to 1000 g a.i./ha, preferably 20-800 g a.i./ha.

In an embodiment, carfentrazone or carfentrazone-ethyl may be used for control of weeds at a dose of 1 to 500 g a.i./ha, preferably 5 to 200 g/ha.

In an embodiment, pyraflufen or pyraflufen-ethyl may be used for control of weeds at a dose of 1 to 500 g a.i./ha, preferably 5 to 200 g a.i./ha.

According to an embodiment, the present invention provides a method of using a synergistic composition comprising clethodim and at least one another herbicide for control or removal of weeds and undesirable vegetation.

According to an embodiment, the present invention provides a method of using a synergistic composition comprising clethodim and at least one another herbicide selected from a PPO inhibitor, an ACCase inhibitor, an ALS inhibitor or an auxin-regulated pathway disruptor for control or removal of weeds.

According to an embodiment, the present invention provides a method of application of a synergistic composition comprising clethodim and at least one another herbicide at a locus of a target plant or weed and undesirable vegetation.

An embodiment of the present invention provides a method of application of a synergistic composition comprising clethodim and an additional herbicide selected from a PPO inhibitor, an ACCase inhibitor, an ALS inhibitor or an auxin-regulated pathway disruptor at a locus of a target plant or weed.

An embodiment of the present invention also provides a method of reducing or eradicating nuisance caused by undesirable vegetation, the said method comprising applying a synergistic composition comprising clethodim and at least one another herbicide.

An embodiment of the present invention also provides a method of reducing or eradicating nuisance caused by undesirable vegetation, the said method comprising applying a synergistic composition comprising clethodim and an additional herbicide selected from a PPO inhibitor, an ACCase inhibitor, an ALS inhibitor or an auxin-regulated pathway disruptor.

In an embodiment, the present invention provides use of a synergistic composition comprising clethodim and a at least one another herbicide selected from pyraflufen, pyraflufen-ethyl, carfentrazone or carfentrazone-ethyl, for control or removal of weeds.

In another embodiment the present invention provides use of a synergistic composition comprising clethodim and a at least one another herbicide selected from pyraflufen, pyraflufen-ethyl, carfentrazone or carfentrazone-ethyl, used for control or removal of weeds from non-agricultural land, amenities, orchards, vines and fruit trees.

According to another specific embodiment, the present invention comprises a method of control or removal of weeds from non-agricultural land, amenities, orchards, vines and fruit trees comprising applying a synergistic composition comprising clethodim and at least one another herbicide selected from pyraflufen, pyraflufen-ethyl, carfentrazone or carfentrazone-ethyl.

In an embodiment, the herbicidal composition is applied effectively to the locus of undesired vegetation in an amount of in the range from about 0.01 L/ha to 20 L/ha, preferred about 0.5 L/ha to 10 L/ha.

Preferably, the present combinations or compositions may be applied either pre or post emergent. The advantage of the combination is surprisingly good residual effects, when applied in pre-emergent as well as quick knockdown when applied post emergent leading to quick control of weeds.

The aforementioned combination may be applied by spraying it onto the field where the targeted weeds are growing and spreading.

The present combination effectively controls certain broadleaved weeds in both pre-emergent and post-emergent conditions.

The combination is applied to controls certain broadleaved weeds in pre-emergent condition.

The compositions of the present invention may be conveniently prepared in concentrated form or in a ready-to-use form.

The present compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

An embodiment of the present invention provides a kit of parts comprising the herbicidal mixture as described herein, or components thereof. Such kits may comprise, in addition to the aforementioned active components, one or more additional active and/or inactive ingredients, either within the provided herbicidal composition or separately.

Thus, in an embodiment, the present invention provides a kit-of-parts comprising a first component of at least one cyclohexanedione herbicide and a second component of at least one other herbicide selected from the group consisting of Protoporphyrinogen Oxidase (PPO) Inhibitors, an Acetyl CoA Carboxylase (ACCase inhibitor), an ALS inhibitor or an auxin-regulated pathway disruptor and combinations thereof.

In another embodiment, the said kit-of-parts further comprises one or more additional components comprising one or more active and/or inactive ingredients. The active and/or inactive ingredients mentioned herein refer to the additional active ingredients and agrochemically acceptable carrier described in the previous embodiments respectively.

In an embodiment, the kit-of-parts comprising an instructions manual, said instructions manual comprising instructions directing a user to admix the components before being used. The components when admixed together produce a synergistic herbicidal mixture.

The invention also provides methods for selective control of weeds. In one embodiment, a method includes contacting a composition of the invention onto a crop plant in need of weed control or at risk of undesirable weeds, in an amount effective to provide weed control in the crop.

Herbicidal activity of the compound combinations can be seen from the examples which follow. That is to say that the present combinations have a synergistic effect. Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described herein.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

The invention is generally disclosed herein using affirmative language to describe the numerous embodiments. The invention also specifically includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. A number of embodiments of the invention have been described. Nevertheless, it will be understood that various modifications may be made without departing from the spirit and scope of the invention. Accordingly, the following examples are intended to illustrate but not limit the scope of invention described in the claims.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### EXAMPLES

### Example 1

Field trials were performed to evaluate the efficacy of present combination, clethodim and carfentrazone-ethyl on annual grass control and dicot control in perennial crops.
Grass weeds targeted: LOLSS, BROSS, ECHSS, DIGSS, SETS S
Dicot weeds targeted: ERISS, GERSS, Sonchus sp., CONAR, Malva sp (rosette stage when application, prior stem elongation, prior flowering, prior ground cover)
Application volume: 300 L/ha

Colby's equation was used to determine the herbicidal effects expected from the mixtures. (See Colby, S. R. Calculation of the synergistic and antagonistic response of herbicide combinations. Weeds 1967, 15, 20-22.)

The following equation was used to calculate the expected activity of mixtures containing two active ingredients, A and B:

Expected=A+B−(A×B/100)
A=observed efficacy of active component A at the same concentration as used in the mixture;
B=observed efficacy of active component B at the same concentration as used in the mixture. The ability of the compositions described herein to afford suitable weed control is illustrated by the efficacy data in Table 3 to 10

Biological Activity Observed with Synergistic Mixtures of Clethodim and Carfentrazone (Carfentrazone-ethyl) in Applications on Digitaria sanguinalis DIGSA (n=2) at 56-59 DAA was represented in table below.

TABLE 1

| | | Observed | | | |
|---|---|---|---|---|---|
| | Carfen- | Efficacy | Calculated | | |
| Clethodim | trazone | (O) in % | Expected | Colby's | Synergism/ |
| dose rate | dose rate | (56-59 | Efficacy | (difference | Antagonism/ |
| (gai/ha) | (gai/ha) | DAA) | (E) in % | O − E) | Additivity |
| 120 | 0 | 95 | NA | NA | NA |
| 180 | 0 | 97 | NA | NA | NA |
| 0 | 30 | 13 | NA | NA | NA |
| 0 | 45 | 27 | NA | NA | NA |
| 0 | 60 | 17 | NA | NA | NA |
| 120 | 30 | 98 | 95.65 | 2.35 | synergism |
| 120 | 60 | 98 | 95.85 | 2.15 | synergism |
| 180 | 30 | 98 | 97.39 | 0.61 | synergism |
| 180 | 45 | 99 | 97.81 | 1.19 | synergism |
| 180 | 60 | 99 | 97.51 | 1.49 | synergism |

Biological Activity Observed with Synergistic Mixtures of Clethodim and Carfentrazone in Applications on Echinochloa crus-galli ECHCG (n=2) 56-59 DAA was represented in table below.

TABLE 2

| | | Observed | | | |
|---|---|---|---|---|---|
| | Carfen- | Efficacy | Calculated | | |
| Clethodim | trazone | (O) in % | Expected | Colby's | Synergism/ |
| dose rate | dose rate | (56-59 | Efficacy | (difference | Antagonism/ |
| (gai/ha) | (gai/ha) | DAA) | (E) in % | O − E) | Additivity |
| 120 | 0 | 84 | NA | NA | NA |
| 180 | 0 | 97 | NA | NA | NA |
| 0 | 30 | 57 | NA | NA | NA |
| 0 | 60 | 59 | NA | NA | NA |
| 120 | 30 | 99 | 93.12 | 5.88 | synergism |
| 120 | 60 | 99 | 93.44 | 5.56 | synergism |
| 180 | 30 | 99 | 98.71 | 0.29 | synergism |
| 180 | 60 | 99 | 98.77 | 0.23 | synergism |

Biological Activity Observed with Synergistic Mixtures of Clethodim and Carfentrazone in Applications on Lolium multiflorum LOLMU (n=2) 56-59 DAA was represented in table below

TABLE 3

| | | Observed | | | |
|---|---|---|---|---|---|
| | Carfen- | Efficacy | Calculated | | |
| Clethodim | trazone | (O) in % | Expected | Colby's | Synergism/ |
| dose rate | dose rate | (56-59 | Efficacy | (difference | Antagonism/ |
| (gai/ha) | (gai/ha) | DAA) | (E) in % | O − E) | Additivity |
| 120 | 0 | 52 | NA | NA | NA |
| 180 | 0 | 74 | NA | NA | NA |
| 0 | 30 | 50 | NA | NA | NA |
| 0 | 45 | 50 | NA | NA | NA |
| 0 | 60 | 50 | NA | NA | NA |
| 120 | 30 | 85 | 76.00 | 9 | synergism |
| 180 | 45 | 92 | 87.00 | 5 | synergism |
| 180 | 60 | 87 | 87.00 | 0 | additivity |

Biological Activity Observed with Synergistic Mixtures of Clethodim and Carfentrazone in Applications on Setaria pumila SETPU (n=1) 56-59 DAA was represented in table below

TABLE 4

| | | Observed | | | |
|---|---|---|---|---|---|
| | Carfen- | Efficacy | Calculated | | |
| Clethodim | trazone | (O) in % | Expected | Colby's | Synergism/ |
| dose rate | dose rate | (56-59 | Efficacy | (difference | Antagonism/ |
| (gai/ha) | (gai/ha) | DAA) | (E) in % | O − E) | Additivity |
| 72 | 0 | 43 | NA | NA | NA |
| 120 | 0 | 50 | NA | NA | NA |
| 180 | 0 | 94 | NA | NA | NA |
| 0 | 12 | 0 | NA | NA | NA |
| 0 | 20 | 0 | NA | NA | NA |
| 0 | 30 | 0 | NA | NA | NA |
| 0 | 45 | 0 | NA | NA | NA |
| 0 | 60 | 0 | NA | NA | NA |
| 72 | 12 | 60 | 43.00 | 17 | synergism |
| 120 | 20 | 92 | 50.00 | 42 | synergism |
| 120 | 30 | 90 | 50.00 | 40 | synergism |
| 120 | 60 | 96 | 50.00 | 46 | synergism |
| 180 | 45 | 96 | 94.00 | 2 | synergism |

Biological Activity Observed with Synergistic Mixtures of Clethodim and Carfentrazone in Applications on Sonchus oleraceus SONOL (n=2) 14-15 DAA

TABLE 5

| | | Observed | | | |
|---|---|---|---|---|---|
| | Carfen- | Efficacy | Calculated | | |
| Clethodim | trazone | (O) in % | Expected | Colby's | Synergism/ |
| dose rate | dose rate | (14-15 | Efficacy | (difference | Antagonism/ |
| (gai/ha) | (gai/ha) | DAA) | (E) in % | O − E) | Additivity |
| 120 | 0 | 13 | NA | NA | NA |
| 0 | 20 | 89 | NA | NA | NA |
| 0 | 30 | 92 | NA | NA | NA |
| 120 | 20 | 97 | 90.43 | 6.57 | synergism |
| 120 | 30 | 97 | 93.04 | 3.96 | synergism |

Biological Activity Observed with Synergistic Mixtures of Clethodim and Carfentrazone in Applications on Convolvulus arvensis CONAR (n=2) 14-15 DAA.

TABLE 6

| | | Observed | | | |
|---|---|---|---|---|---|
| | Carfen- | Efficacy | Calculated | | |
| Clethodim | trazone | (O) in % | Expected | Colby's | Synergism/ |
| dose rate | dose rate | (14-15 | Efficacy | (difference | Antagonism/ |
| (gai/ha) | (gai/ha) | DAA) | (E) in % | O − E) | Additivity |
| 72 | 0 | 8 | NA | NA | NA |
| 120 | 0 | 12 | NA | NA | NA |
| 180 | 0 | 8 | NA | NA | NA |
| 0 | 12 | 58 | NA | NA | NA |
| 0 | 60 | 93 | NA | NA | NA |
| 72 | 12 | 82 | 61.36 | 20.64 | synergism |
| 120 | 60 | 94 | 93.84 | 0.16 | synergism |
| 180 | 60 | 95 | 93.56 | 1.44 | synergism |

Biological Activity Observed with Synergistic Mixtures of Clethodim and Carfentrazone in Applications on Portulaca oleracea POROL (n=1) 14 DAA.

TABLE 7

| | Carfen- | Observed | Calculated | | |
|---|---|---|---|---|---|
| Clethodim | trazone | Efficacy | Expected | Colby's | Synergism/ |
| dose rate | dose rate | (O) in % | Efficacy | (difference | Antagonism/ |
| (gai/ha) | (gai/ha) | (14 DAA) | (E) in % | O − E) | Additivity |
| 120 | 0 | 0 | NA | NA | NA |
| 180 | 0 | 0 | NA | NA | NA |
| 0 | 20 | 90 | NA | NA | NA |
| 0 | 30 | 97 | NA | NA | NA |
| 0 | 45 | 100 | NA | NA | NA |
| 0 | 60 | 100 | NA | NA | NA |
| 120 | 20 | 97 | 90.00 | 7 | synergism |
| 180 | 30 | 100 | 97.00 | 3 | synergism |
| 120 | 60 | 100 | 100.00 | 0 | additivity |
| 180 | 45 | 100 | 100.00 | 0 | additivity |
| 180 | 60 | 100 | 100.00 | 0 | additivity |

Biological Activity Observed with Synergistic Mixtures of Clethodim and Carfentrazone in Applications on Senecio vulgaris SENVU (n=1) 14 DAA.

TABLE 8

| | Carfen- | Observed | Calculated | | |
|---|---|---|---|---|---|
| Clethodim | trazone | Efficacy | Expected | Colby's | Synergism/ |
| dose rate | dose rate | (O) in % | Efficacy | (difference | Antagonism/ |
| (gai/ha) | (gai/ha) | (14 DAA) | (E) in % | O − E) | Additivity |
| 72 | 0 | 0 | NA | NA | NA |
| 120 | 0 | 2 | NA | NA | NA |
| 180 | 0 | 0 | NA | NA | NA |
| 0 | 12 | 88 | NA | NA | NA |
| 0 | 20 | 92 | NA | NA | NA |
| 0 | 30 | 97 | NA | NA | NA |
| 0 | 45 | 100 | NA | NA | NA |
| 0 | 60 | 100 | NA | NA | NA |
| 72 | 12 | 92 | 88.00 | 4 | synergism |
| 120 | 20 | 98 | 92.16 | 5.84 | synergism |
| 120 | 30 | 100 | 97.06 | 2.94 | synergism |
| 180 | 30 | 100 | 97.00 | 3 | synergism |
| 120 | 60 | 100 | 100.00 | 0 | additivity |
| 180 | 45 | 100 | 100.00 | 0 | additivity |
| 180 | 60 | 100 | 100.00 | 0 | additivity |

Symptoms were visible from 3 days after application on most broad leaf weeds with good efficacy. Best high and fast control was observed on annual broad leaf weeds vs. perennials. Efficacy increased overtime to reach a peak at 14-15 DAA for most of the weeds.

Thus, it is concluded that combinations or compositions of the present invention are effective for targeted weed control.

### Example 2

Field trials were performed to evaluate the efficacy of present combination, clethodim and pyraflufen (pyraflufen-ethyl) on difficult annual grasses and perennials in apple trees. The result of trials are represented in below tables.

TABLE 9
Efficacy in % of the different formulations on Setaria sp. at 60 DAT
Crop- Apple

| Treatments- 1 application | | |
|---|---|---|
| against annuals & perennials | AI g/ha | % Control |
| Untreated | 0 | 0 |
| Clethodim + Pyraflufen | 125 + 12 | 62 |
| Clethodim + Pyraflufen | 187.5 + 18 | 82 |
| Clethodim + Pyraflufen | 250 + 24 | 92 |
| Clethodim + Pyraflufen | 125 + 12 | 72 |
| Clethodim + Pyraflufen | 187.5 + 18 | 80 |
| Clethodim + Pyraflufen | 250 + 24 | 90 |
| Clethodim + Pyraflufen | 500 + 48 | 97 |

It was concluded that the combination of clethodim and pyraflufen was very effective in controlling difficult annual grasses and perennials.

### Example 3

Clethodim and pyraflufen-ethyl were tested on table grapes as individual applications, premix and tank-mix combinations. The products were formulated as an EC formulation and compared with Glufosinate SC. Effect of the treatment was checked on Setaria weeds at 28 days after treatment.

TABLE 10

| | | | Weed | | |
|---|---|---|---|---|---|
| | | | control % | | |
| Trt. | | g | (Observed | Expected | |
| No | Treatment | ai/ha | efficacy) | efficacy | O − E |
| 1 | Untreated | — | 0 | NA | NA |
| 2 | Clethodim | 125 | 85 | NA | NA |
| 3 | Pyraflufen-Ethyl | 12 | 0 | NA | NA |
| | (formulated with | | | | |
| | mineral oil) | | | | |
| 4 | Clethodim + | 12 + 125 | 87.5 | 85 | 2.5 |
| | Pyraflufen- | | | | |
| | ethyl premix | | | | |
| 5 | Clethodim + | 12 + 125 | 91 | 85 | 6 |
| | Pyraflufen- | | | | |
| | ethyl tankmix | | | | |
| 6 | Clethodim + | 24 + 250 | 100 | 85 | 15 |
| | Pyraflufen- | | | | |
| | ethyl tankmix | | | | |
| 7 | Glufosinate | 700 | 85 | NA | NA |

From the above table, it is evident that clethodim and pyraflufen-ethyl exert synergistic effects in control of weeds. It is also noteworthy that the effect produced by a combination of clethodim and pyraflufen-ethyl (tank-mix or premix) is more pronounced than glufosinate treatment at lesser rates of active ingredients. This provides an ecological advantage in terms of less chemical application in field.

### Example 4

Pot trials for clethodim, pyraflufen-ethyl and their combination (premix and tan-mix) were carried out against green foxtail, large crabgrass and Bermuda grass

TABLE 11
Efficacy checked at 4 DAT

| | | Green foxtail | | |
|---|---|---|---|---|
| | Dose | % control | Expected | |
| Treatment | gai/ha | (observed) | efficacy | O − E |
| Clethodim | 250 | 25 | NA | NA |
| Pyraflufen-ethyl | 24 | 20 | NA | NA |
| Clethodim + Pyraflufen- | 24 + 250 | 75 | 73.75 | 1.25 |
| ethyl premix | | | | |
| Clethodim + Pyraflufen- | 24 + 250 | 75 | 73.75 | 1.25 |
| ethyl tank mix | | | | |
| Glufosinate | 700 | 75 | NA | NA |
| 18.50 AL | 350 | 65 | NA | NA |

TABLE 12

| | | Large crabgrass | | |
|---|---|---|---|---|
| | | (control checked at 4 DAT) | | |
| | Dose | % control | Expected | |
| Treatment | gai/ha | (observed) | efficacy | O − E |
| Clethodim | 250 | 20 | NA | NA |
| Pyraflufen-ethyl | 24 | 10 | NA | NA |
| Clethodim + | 24 + 250 | 58 | 56 | 2 |
| Pyraflufen-ethyl | | | | |
| premix | | | | |

TABLE 13

| | | Bermuda grass | | |
|---|---|---|---|---|
| | | (control checked at 4 DAT) | | |
| | Dose | % control | Expected | |
| Treatment | gai/ha | (observed) | efficacy | O − E |
| Clethodim | 250 | 20 | NA | NA |
| Pyraflufen-ethyl | 24 | 10 | NA | NA |
| Clethodim + Pyraflufen- | 24 + 250 | 45 | 33.5 | 11.5 |
| ethyl premix | | | | |
| Clethodim + Pyraflufen- | 24 + 250 | 50 | 33.5 | 16.5 |
| ethyl tank mix | | | | |

From the above table, it is evident that clethodim and pyraflufen-ethyl exert synergistic effects in control of weeds.

### Example 5

Clethodim+Carfentrazone 120+20 g/l EC was formulated as follows:

TABLE 14

| Ingredients | Amount % |
|---|---|
| Clethodim | 12.00 |
| Carfentrazone-ethyl | 2.00 |
| Fatty acid esters | 41.26 |
| Polyoxyethylene (20) sorbitan monooleate | 5.00 |
| Mixture of Dimethyl adipate, Dimethyl | 34.739 |
| glutarate, Dimethyl succinate | |

1. A synergistic herbicidal combination comprising at least one cyclohexanedione herbicide and at least one other herbicide selected from the group consisting of PPO inhibitors, acetyl CoA carboxylase inhibitors (ACCase inhibitors), ALS inhibitors, auxin-regulated pathway disruptors, and combinations thereof.

2. The combination as claimed in claim 1, wherein the cyclohexanedione herbicide is clethodim.

3. The combination as claimed in claim 1, wherein the PPO inhibitor is selected from group consisting of diphenylethers, N-phenylphthalimides, phenylpyrazoles oxadiazoles, thiadiazoles, triazolinonse, oxazolidinediones, pyrimidinediones, and combinations thereof

4. The combination as claimed in claim 3, wherein the PPO inhibitor is selected from group consisting of acifluorfen, fomesafen, lactofen, flumiclorac, flumioxazin, sulfentrazone, carfentrazone, fluthiacet-ethyl and saflufenacil, azafenidin, benzfendizone, bifenox, butafenacil, carfentrazone, carfentrazone-ethyl, chlomethoxyfen, cinidon-ethyl, fluazolate, flufenpyr-ethyl, flumiclorac-pentyl, fluoroglycofen-ethyl, fluthiacet-methyl, fomesafen, halosafen, lactofen, oxadiargyl, oxadiazon, oxyfluorfen, pentoxazone, profluazol, pyraclonil, pyraflufen-ethyl, saflufenacil, thidiazimin, trifludimoxazin, tiafenacil.

5. The combination as claimed in claim 4, wherein the PPO inhibitor is carfentrazone or carfentrazone-ethyl.

6. The combination as claimed in claim 4, wherein the PPO inhibitor is pyraflufen or pyraflufen-ethyl.

7. A synergistic composition comprising a synergistic combination of a cyclohexanedione herbicide and at least one other herbicide selected from the group consisting of PPO inhibitors, acetyl CoA carboxylase inhibitors (ACCase inhibitors), ALS inhibitors, auxin-regulated pathway disruptors, and combinations thereof, wherein the cyclohexanedione herbicide is clethodim.

8. The synergistic composition of claim 7, wherein the at least one other herbicide is selected from the group consisting of carfentrazone, carfentrazone-ethyl, pyraflufen, and pyraflufen-ethyl.

9. The composition as claimed in claim 7, wherein the composition further comprises at least one agrochemically acceptable carrier.

10. A method of making theft synergistic composition of claim 7 for control or removal of weeds and undesirable vegetation, wherein the method comprises mixing the clethodim and the at least one other herbicide.

11. (canceled)

12. A method of controlling weeds and undesirable vegetation at a locus, said method comprising applying to the locus the synergistic herbicidal combination of claim 1.

13. The method as claimed in claim 12, wherein the said herbicidal combination is applied to non-agricultural land, amenities, forestries, orchards, vines, or fruit trees.

14. The method as claimed in claim 12, wherein the cyclohexanedione herbicide is clethodim and the at least one other herbicide is selected from the group consisting of carfentrazone, carfentrazone-ethyl, pyraflufen, and pyraflufen-ethyl.

15. The method as claimed in claim 14, wherein the clethodim is applied at a dose of 10 to 1000 g a.i./ha and the carfentrazone, carfentrazone-ethyl, pyraflufen or pyraflufen-ethyl are applied at a dose of 1 to 500 g a.i./ha.

16. The method as claimed in claim 12, wherein the said synergistic herbicidal combination is applied in pre-emergent conditions, in post-emergent conditions, or both.

17. (canceled)

18. A kit-of-parts comprising a first component of at least one cyclohexanedione herbicide and a second component of at least one other herbicide selected from the group consisting of protoporphyrinogen oxidase (PPO) Inhibitors, acetyl CoA carboxylase inhibitors (ACCase inhibitor), ALS inhibitors, auxin-regulated pathway disruptors and combinations thereof, wherein said cyclohexanedione herbicide is clethodim.

19. The kit-of-parts as claimed in claim 18, wherein the kit-of-parts further comprises one or more additional components comprising one or more active and/or inactive ingredients.

20. The kit-of-parts as claimed in claim 18, wherein the said kit-of-parts produces a synergistic mixture when the first and second components are combined together.
